(19) United States
(12) Patent Application Publication
(10) Pub. No.: US 2008/0015715 A1
(43) Pub. Date: Jan. 17, 2008

(54) Card reader for audio player

(75) Inventor: Yu-Tao Shen, Hsinchu County (TW)

Correspondence Address: BACON & THOMAS, PLLC, 625 SLATERS LANE, FOURTH FLOOR, ALEXANDRIA, VA, 22314, US

(73) Assignee: SUN VALLEY INFO. CORP., HSIN-CHU (TW)

(21) Appl. No.: 11/483,531

(22) Filed: Jul. 11, 2006

(51) Int. Cl. G06F 17/00

(52) U.S. Cl. 700/94

(57) ABSTRACT

A card reader of the present invention includes a central processing unit (CPU), a conversion unit, an access device and an audio device. The access device has a storage device, in which music compressed files are stored. The conversion unit extracts the compressed file to a digital audio signal and converts it to analog audio signal to be broadcasted by speaker. The audio device may receives music files, and the conversion unit converts the file to digital audio signal and compresses it to compressed file, and then store it in the storage device of the access device. The card reader of the present invention has both function of playing and recording the digital music files.

### BACKGROUND OF THE INVENTION

1. Field of the Invention

The present invention relates generally to an audio player, and more particularly to a card reader of the audio player (Hi-Fi system) for playing and recording.

2. Description of the Related Art

As the faster progress of internet and multimedia, many companies are working on integration of multimedia and the software and hardware of computer. For example, the MP3 (MPEG-1 Layer 3) player is an integrated product of digital file compression technique, signal process and playing. If the player is provided with a socket, which the reading interface and player are compatible, to insert memory card with small size therein, the player may play the music files stored in the memory card, which may be processed in computer or downloaded from internet. It doesn't need to store the files in the build-in memory, which usually has a small capacity, of the player. The memory card usually has a large capacity to store more files therein. If the total size of the files is greater than the capacity of the memory card, it only has to store parts of files in another memory card. The memory cards usually have smaller sizes that take less space to carry, such that user may listen more music by the player.

FIG. 1 shows a conventional music player 1, which includes a microprocessor 11, a memory card reader 12 connected to the microprocessor 11, an operation interface 13, a buffer 14, a program memory 15, a decoder 16 and a speaker 17 connected to the decoder 16. The memory card reader 12 is able to connect a flash memory card including MMC (Multi Media Card), SD (Secure Digital), SM (Smart Media), MS (Memory Stick) and other memory cards. The operation interface 13 is an interface for user to operate the player including power, play, audio control and infrared ray remote control module etc. The buffer 14 may temporarily store the file to increase the speed of microprocessor 11. The buffer 14 may be static random access memory (SRAM) or dynamic random access memory (DRAM). The program memory 15 is a read only memory (ROM) storing system programs therein. The decoder 16 extracts the compressed file and transfers it to analog audio signal to broadcast in the speaker 17. When a memory card is inserted in the memory card reader 12, the user may operate the operation interface 13 to control the microprocessor 11 reading the file in the memory card and storing it in the buffer 14, then the program memory 15 provides the suitable program to decode the file in the decoder 16 and broadcast in the speaker 17.

Of course, user has to get the music files and compress encode them in computer or download the encoded files from internet, and then store the files in the memory card. It takes too much time in the file prior to listening music by the player.

### SUMMARY OF THE INVENTION

The primary objective of the present invention is to provide a card reader of an audio player, which may encode the files without computer for playing and recording digital audio files.

According to the objective of the present invention, a card reader of the present invention includes a central processing unit (CPU), a conversion unit, an access device and an audio device. The CPU is a microprocessor integrating logic calculating chip with random access memory, which has a control end module electrically connected to the audio device to be a serial bus interface for two-way transferring digital data. The conversion unit is electrically connected to the CPU including a digital end module, an analog end module, a converter and an encoder/decoder. The encoder/decoder has an integral encoding and decoding circuitry electrically connected to the digital end module and the converter to extract the compressed file to digital audio signal and to compress the digital audio signal to compressed file. The inverter is an A/D converter electrically connected to the analog end module to convert the digital audio signal to analog audio signal. The analog end module transfers the analog audio signal, and the digital end module transfers the digital audio signal. The access device includes at least a storage space and interface circuitry. The storage space receives a storage device, which is a non-volatile memory, and the interface circuitry is electrically connected to the digital end module for conversion between the electrical signals of the corresponding storage device and the digital signal of the digital end module. The audio device is electrically connected to the control end module and the analog end module including an amplifier, an input end module and an output end module. The amplifier is electrically connected to the input end module, the output end module and the analog end module for potential power conversion between analog audio signal and the audio signal output to the speaker. The input and output end modules are for inputting and outputting audio signal.

The compressed files in the storage device may be read, compressed to digital audio signal by the encoder/decoder, converted to analog audio signal by the converter, and amplified by the amplifier. And then the output end module outputs the audio signal, and the input end module receives music source. Next, the signal transfers to the amplifier to be converted to the analog audio signal with suitable potential power, the converter to be converted to digital audio signal, the encoder/decoder to be compressed to a digital compressed file and the storage device through the digital end module in sequence.

### BRIEF DESCRIPTION OF THE DRAWINGS

FIG. 1 is a block diagram of the conventional digital audio player;

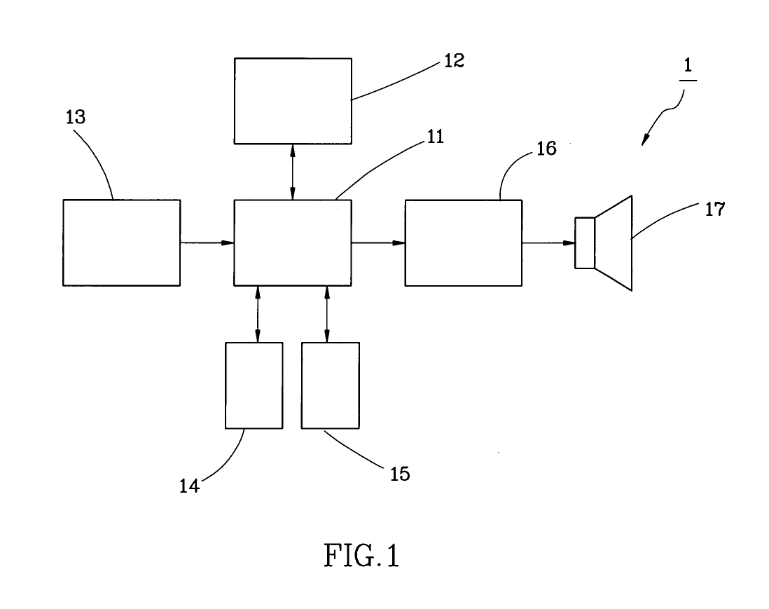

FIG. 2 is a block diagram of a first preferred embodiment of the present invention;

FIG. 3 is a sketch diagram of an application of the first preferred embodiment of the present invention; and

FIG. 4 is a block diagram of a second preferred embodiment of the present invention.

### DETAILED DESCRIPTION OF THE INVENTION

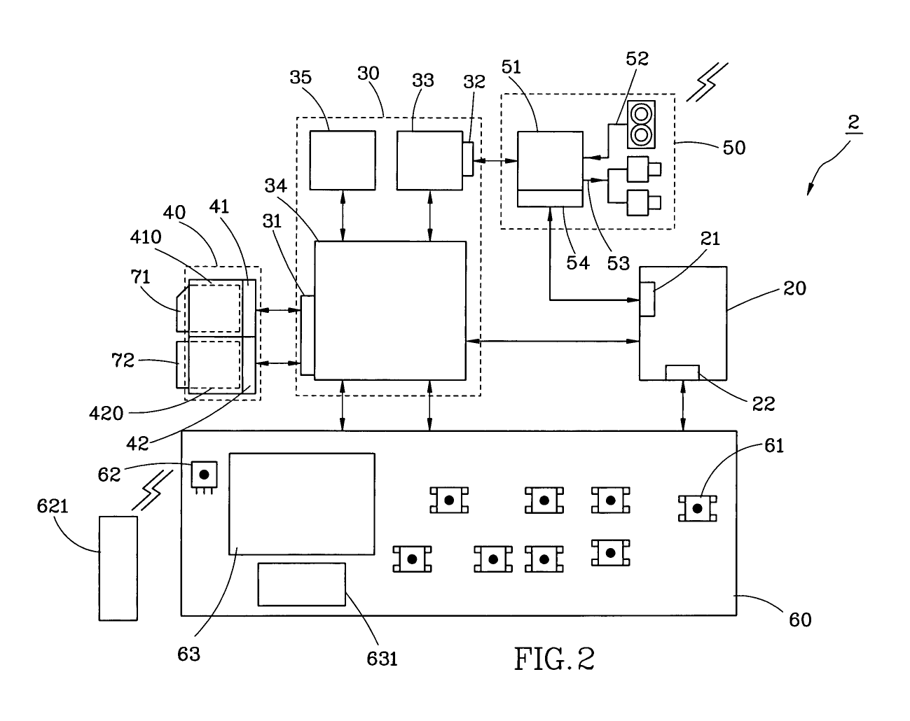

As shown in FIG. 2, a card reader 2 of an audio player, such as MP3 player, of the first preferred embodiment of the present invention comprises a central processing unit (CPU) 20, a conversion unit 30, an access device 40, an audio device 50 and a control panel 60.

The CPU 20 is a microprocessor integrating logic calculating chip with random access memory, which includes a control end module 21 and an I/O (Input/Output) interface 22. The control end module 21 is electrically connected to the audio device 50 to be an interface of for two-way transferring digital data. In the present invention, the control end module 21 is I2C (Inter-IC) interface. The I/O interface 22 is electrically connected to the control panel 60 to convert the electrical signal to a specific spec compatible to the chip inside.

The conversion unit 30 includes a digital end module 31, an analog end module 32, a converter 33, an encoder/decoder 34 and a memory device 35. The digital end module 31 transfers digital signal, and the analog end module 32 transfers analog signal. The converter 33 is an A/D converter electrically connected to the analog end module 32 for conversion between digital audio signal and analog audio signal. The encoder/decoder 34 is electrically connected to the CPU 20, the control panel 60, the digital end module 31, the converter 33 and the memory device 35 to integrate digital decoding circuitry and encoding circuitry. The decoding circuitry extracts the compressed file of digital signal to digital audio signal, and the encoding circuitry compresses the digital audio signal to compressed file. The memory device 35 is a read only memory (ROM) made of non-volatile memory, and it is an EPROM (erasable programmable read-only memory) in the present invention. The memory device 35 stores the programs for the encoder/decoder 34.

The access device 40 includes two interface circuitries 41, 42 and two sockets 410, 420. Storage devices may be inserted into the sockets 410, 420. In the present invention, the storage devices are flash memory, such as SD card 71 and USB portable storage device 72, and the interface circuitries 41, 42 are SD interface and USB interface. The interface circuitries 41, 42 are electrically connected to the digital end module 31 for conversion between electrical signal of the storage device and the transferring spec of the digital signal of the digital end module 31.

The audio device 50 includes an amplifier 51, an input end module 52, an output end module 53 and a switch circuitry 54. The amplifier 51 is electrically connected to the input end module 52, the output end module 53 and the switch circuitry 54 for potential power conversion between analog audio signal and the audio signal. The input end module 52 is where the audio signal is inputted, which is connected to the audio output of the player. The output end module 53 is where the audio signal outputs, which is connected to the audio input of a Hi-Fi system or a speaker system, such as speakers or earphones, of the player.

The switch circuit 54 is designed to control the output of the amplifier 51, the purpose of this design is to prevent some noise generated during the system on/off time period or the time when the system is selecting for get the audio from different input source.

The control panel 60 provides many keys 61, an infrared ray receiver 62 and a display panel 63. The keys 61 send digital control signals to the conversion unit 30. The infrared ray receiver 62 receives the infrared ray signals from a remote control 621, which has a circuitry to separate an electrical control signal from the infrared ray signals and send the electrical control signals to the CPU 20 through the I/O interface 22. The CPU 20 processes the control signals and sends the specific control signals to the conversion unit 30 to control the conversion unit 30 according to the command of the keys 61 or the remote control 621. The display panel is a LCD, which is electrically connected to a driving chip 631. The conversion unit 30 provides control signals to drive the driving chip 631 providing AC voltage signal to the display panel 63 to scan and drive predetermined pixels for showing predetermined image. As a result, the display panel 63 shows every status of the card reader 2 synchronously.

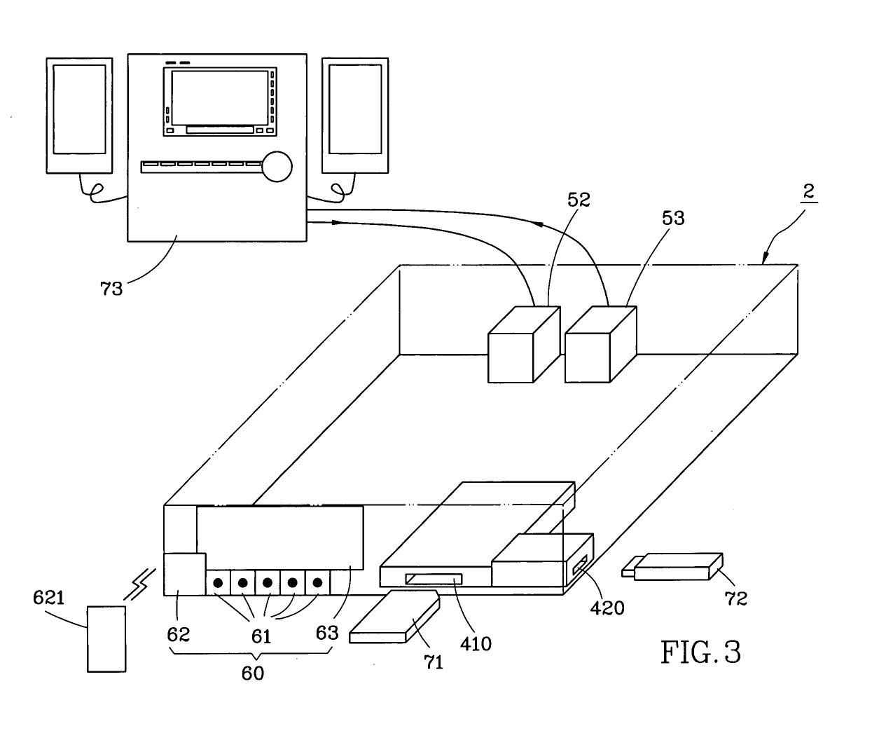

As shown in FIG. 3, the card reader 2 of the present invention is incorporated in an audio player 73. When the SD card 71 and the USB portable storage device 72 are inserted into the sockets 410, 420, user may operate the keys 61 to send control signal to the conversion unit 30. User also may operate the remote control 621, and the infrared ray receiver 62 receives the signal and sends it to the CPU 20. The CPU 20 converts the signal to digital control signal and sends it to the conversion unit 30. That is the ways to control the card reader 2 of the present invention. When the command is playing the compressed files stored in the SD card 71 or in the USB portable storage device 72, the corresponding interface circuitries 41 or 42 converts the compressed files to the predetermined format that can be recognized by the CPU 20 and sends it to the CPU 20 through the conversion unit 30. The RAM temporarily stores the file, and then the decoding circuitry of the encoder/decoder 34 reads the predetermined file from the CPU 20 according to the command and extracts the file to digital audio signal. The digital audio signal is sent to the converter 33, and a DAC (Digital to Analog Converter) of the converter 33 converts it to analog audio signal. The analog audio signal is sent to the amplifier 51 through the analog end module 32 to amplify the power of the analog audio signal for broadcasting via the speaker of the audio player 73. If there is a new source CD, it may be put in the audio player 73 for playing. User also may operate the control panel 60 to send the signal of the CD to the card reader 2 of the present invention through the input end module 52. The amplifier 51 amplifies the signal to an analog audio signal with suitable potential power, and an ADC (Analog to Digital Converter) of the converter 33 compresses it to digital compressed file to be stored in the SD card 71 or the USB portable storage device 72 through the digital end module 31. Therefore, any source music file, such as the files in CD or FM, AM signal, may be recorded in the SD card 71 or the USB portable storage device 72 by the card reader 2 of the present invention. There is no computer involved in the file conversion process. The card reader 2 of the present invention has both function of playing and recording digital audio files.

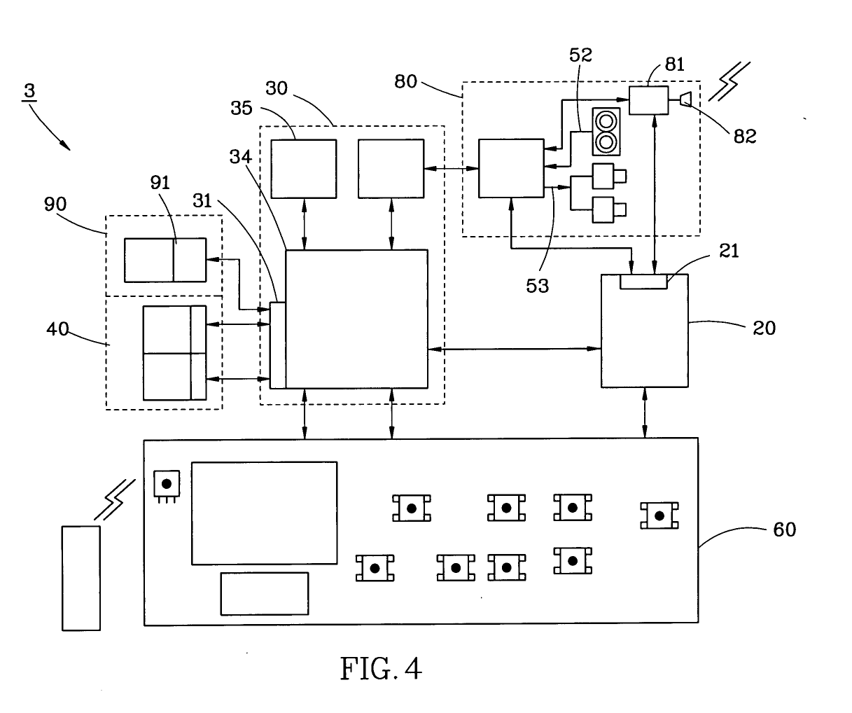

It is noted that the card reader of the present invention may be connected to the audio player by wireless technique. As shown in FIG. 4, a card reader 3 of the second preferred embodiment of the present invention is provided with an audio device 80 with a high frequency circuitry to replace the audio device 50 of the first embodiment and a system detection circuitry 90 electrically connected to digital end module 31 the conversion unit 30 to update the driver of the encoder/decoder 34. The audio device 80 has a RF (radio frequency) circuitry 81 and an antenna 82 for high frequency wireless communication. The RF circuitry 81 is electrically connected to the control interface 21, the antenna 82, the input end module 52 and the output end module 53. The antenna 82 receives and emits 2.4 GHz RF signal, which is the bandwidth of lower noise and lower transmission power. The system detection circuitry 90 has a Universal Asynchronous Receiver/Transmitter (UART) interface 91 to provide various drivers to the encoder/decoder 34 and upload the newest version driver to the memory device 35 to update the driver of the encoder/decoder 34 by UART. Therefore, if the audio player is equipped with a RF circuitry with specific frequency, the card reader 3 of the present invention may receive the RF signal carrying audio signal from the audio player by the antenna 82 and play and record the audio files. Except for the 2.4 GHz RF signal circuitry, the audio device 80 also may be equipped with Bluetooth® module circuitry to achieve the same function.

The description above only includes few preferred embodiments and the equivalence of the present invention is still in the scope of the claim of the present invention.

What is claimed is:

1. A card reader, comprising:
a central processing unit having a control end module;
a conversion unit, which is electrically connected to the central processing unit, having a digital end module, an analog end module, a converter and an encoder/decoder, wherein the encoder/decoder, which has an integrated encoding and decoding circuitry, is electrically connected to the digital end module and the converter to extract a compressed file to a digital audio signal and to compress a digital audio signal to a compressed file, and the converter is a analog/digital converter electrically connected to the analog end module for conversion of a digital audio signal and an analog audio signal, and the analog end module transfers the analog audio signal, and the digital end module transfers the digital audio signal;
an access device having at least a storage space and at least an interface circuitry, wherein the storage space receive a storage device made of non-volatile memory, and the interface circuitry is electrically connected to the digital end module for conversion of an electrical signal of the corresponding storage device and the digital signal of the digital end module;
an audio device, which is electrically connected to the control end module and the analog end module, having an amplifier, an input end module and an output end module, wherein the amplifier is electrically connected to the input end module, the output end module and the analog end module, and an audio signal is inputted and outputted through the input end module and the output end module respectively, and the amplifier provides power amplify for the analog audio signal to the output end module.

2. The card reader as defined in claim 1, wherein the interface circuitry is a universal serial bus (USB) interface.

3. The card reader as defined in claim 1, wherein the interface circuitry is a secure digital (SD) input/output interface.

4. The card reader as defined in claim 1, wherein the conversion unit has a memory device, which is a read only memory (ROM) made of non-volatile memory, electrically connected to the encoder/decoder to store drivers for the encoder/decoder.

5. The card reader as defined in claim 4, wherein the memory device is an erasable programmable read-only memory (EPROM).

6. The card reader as defined in claim 5, further comprising a system detection circuitry electrically connected to the digital end module of the conversion unit to detect the drivers in the memory device and to upload a new driver to the storage device to update the drivers for the encoder/decoder.

7. The card reader as defined in claim 6, wherein the system detection circuitry has a Universal Asynchronous Receiver/Transmitter (UART) interface electrically connected to the digital end module of the conversion unit.

8. The card reader as defined in claim 1, wherein the control interface is a serial bus interface of for two-way transferring digital data.

9. The card reader as defined in claim 8, wherein the control interface is a I2C (Inter-IC) interface.

10. The card reader as defined in claim 1, further comprising a control panel, which is electrically connected to the conversion unit and the central processing unit, having a plurality of keys and a display panel, wherein the keys send control signals to the conversion unit to control the card reader running, and the display panel shows information of card reader.

11. The card reader as defined in claim 10, wherein the display panel is a liquid crystal display, and the control panel further has a driving chip electrically connected to the display panel and the conversion unit, whereby the conversion unit provides a control signal to drive the driving chip, and the driving chip provides an analog signal to the display panel to scan and drive predetermined pixels showing predetermined colors, such that the display panel shows functions and status of the card reader.

12. The card reader as defined in claim 10, wherein the control panel further includes an infrared ray receiver to receive an infrared ray signal, which has a circuitry to separate an electrical control signal from the infrared ray signals and send the electrical control signals to the central processing unit.

13. The card reader as defined in claim 1, wherein the audio device has a switch circuitry electrically connected to the amplifier and the control interface to control an output of the amplifier on/off.

14. The card reader as defined in claim 1, wherein the audio device has a high frequency circuitry and an antenna, and the radio frequency circuitry is electrically connected to the control interface, the antenna, the input end module and the output end module, and the antenna receives and transmits wireless high frequency signal compatible to the high frequency circuitry.

15. The card reader as defined in claim 14, wherein the high frequency circuitry is a 2.4 GHz radio frequency circuitry.

16. The card reader as defined in claim 14, wherein the high frequency circuitry is a Bluetooth module circuitry.
